(19) United States
(12) Patent Application Publication
(10) Pub. No.: US 2020/0249735 A1
(43) Pub. Date: Aug. 6, 2020

(54) CHARGE CONTROL APPARATUS AND CHARGE CONTROL SYSTEM

(71) Applicant: FUJITSU CLIENT COMPUTING LIMITED, Kanagawa (JP)

(72) Inventor: Tomonori Fujii, Kawasaki (JP)

(73) Assignee: FUJITSU CLIENT COMPUTING LIMITED, Kanagawa (JP)

(21) Appl. No.: 16/697,987

(22) Filed: Nov. 27, 2019

(30) Foreign Application Priority Data
Jan. 31, 2019 (JP) 2019-015197

(51) Int. Cl. G06F 1/26; H02J 7/00

(52) U.S. Cl. CPC G06F 1/266; H02J 7/0045; H02J 7/0047; H02J 7/007

(57) ABSTRACT

A charge control apparatus includes a memory and a first hardware processor coupled to the memory. The first hardware processor: acquires, from one or more terminal devices, charge information relating to a charge of the one or more terminal devices; and controls charging of the one or more terminal devices based on the charge information.

### CROSS-REFERENCE TO RELATED APPLICATIONS

This application is based upon and claims the benefit of priority from Japanese Patent Application No. 2019-015197, filed Jan. 31, 2019, the entire contents of which are incorporated herein by reference.

### FIELD

Embodiments described herein relate to a charge control apparatus and a charge control system.

### BACKGROUND

Terminal devices including rechargeable batteries, such as smartphones and tablet personal computers (PCs), have recently been in wide use. In such terminal device, a power management unit (PMU) provided therein controls charging of the battery.

In addition, there are known techniques of monitoring charging conditions of the terminal devices from externals.

However, those conventional techniques entail have difficulties in externally controlling the charging of the terminal devices.

### SUMMARY

A charge control apparatus according to one aspect of the present disclosure includes a memory and a first hardware processor coupled to the memory. The first hardware processor is configured to: acquire, from one or more terminal devices, charge information relating to charge; and control charging of the one or more terminal devices based on the charge information.

### BRIEF DESCRIPTION OF THE DRAWINGS

FIG. 1 is a diagram illustrating an example of a whole configuration of a charge control system according to a first embodiment;

FIG. 2 is a diagram illustrating an example of a hardware configuration of a terminal device in the first embodiment;

FIG. 3 is a diagram illustrating an example of a functional configuration of a PMU of the terminal device in the first embodiment;

FIG. 4 is a diagram illustrating an example of charge information in the first embodiment;

FIG. 5 is a diagram illustrating an example of a hardware configuration of a charge control apparatus in the first embodiment;

FIG. 6 is a diagram illustrating an example of a functional configuration of the charge control apparatus in the first embodiment;

FIG. 7 is a diagram illustrating an example of a hardware configuration of a power supply device in the first embodiment;

FIG. 8 is a sequence diagram illustrating an example of a charge control process in the first embodiment;

FIG. 9 is a diagram illustrating an example of transmission time information in a second embodiment;

FIG. 10 is a sequence diagram illustrating an example of a charge control process in the second embodiment;

FIG. 11 is a diagram illustrating an example of charge information in a fourth embodiment; and

FIG. 12 is a diagram illustrating an example of a whole configuration of a charge control system in a fifth embodiment.

### DETAILED DESCRIPTION

### First Embodiment

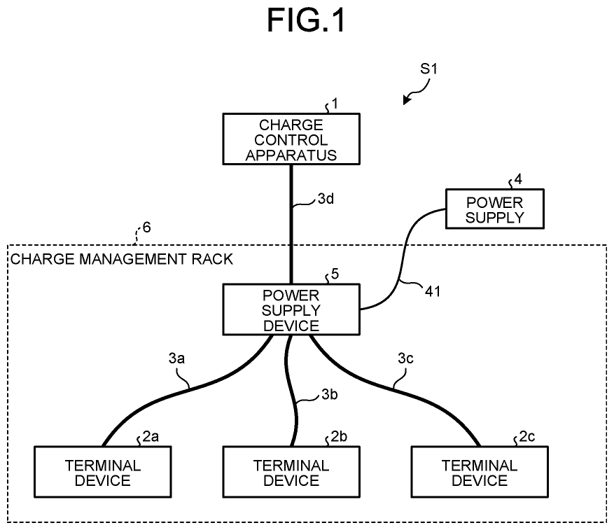

FIG. 1 is a diagram illustrating an example of a whole configuration of a charge control system S1 according to a first embodiment. As illustrated in FIG. 1, the charge control system S1 includes a charge control apparatus 1, one or more terminal devices 2a, 2b, and 2c, and a power supply device 5. With regard to the terminal devices 2a to 2c, when one is not to be differentiated from others, they will hereinafter be referred to simply as a terminal device 2 or terminal devices 2. The number of terminal devices 2 included in the charge control system S1 and illustrated in the example of FIG. 1 is not limited thereto.

The charge control apparatus 1, the terminal devices 2, and the power supply device 5 are connected with each other via cables 3a to 3d. Regarding the cables 3a to 3d, when one is not to be differentiated from others, they will hereinafter be referred to simply as a cable 3 or cables 3. The cable 3 is a universal serial bus power delivery (USB) Type-C cable conforming to the USB Type-C standard. The cable 3 is not limited only to the USB Type-C cable. The cable 3 is only required to be capable of transmitting and receiving power and data.

The terminal device 2 may be, for example, a smartphone, a tablet PC, or a laptop PC and includes a rechargeable battery.

The power supply device 5 supplies power obtained from a power supply 4 to the terminal device 2 and the charge control apparatus 1. The power supply device 5 relays communication between the terminal device 2 and the charge control apparatus 1. The power supply 4 is, for example, an AC power supply such as a commercial power supply.

The charge control apparatus 1 is, for example, a PC and controls charge of the terminal device 2. The charge control apparatus 1 may obtain power from another power supply without via the power supply device 5.

The power supply device 5 is disposed in, for example, a charge management rack 6 as illustrated in FIG. 1. A user or the like may put the terminal device 2 into the charge management rack 6 and connect the cable 3 to the power supply device 5. This causes the terminal device 2 to be ready for receiving supply of power from the power supply device 5. An administrator or the like may operate the charge control apparatus 1 to control charging of the terminal device 2. It is noted that, in the first embodiment, a person who uses the terminal device 2 is referred to as a user and a person who uses the charge control apparatus 1 is referred to as an administrator. The user and the administrator may nonetheless be an identical person.

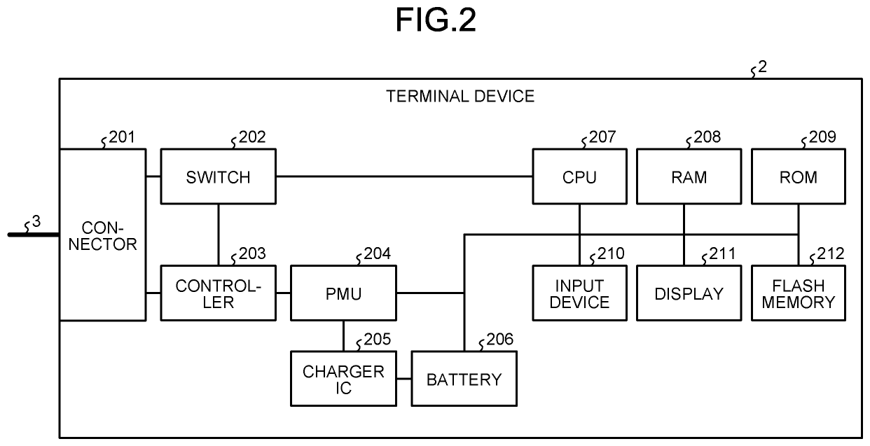

FIG. 2 is a diagram illustrating an example of a hardware configuration of the terminal device 2 in the first embodiment. As illustrated in FIG. 2, the terminal device 2 is provided with a central processing unit (CPU) 207, a random access memory (RAM) 208, a read only memory (ROM) 209, an input device 210, a display 211, and a flash memory 212 or another external storage device. The input device 210 is, for example, a keyboard, a mouse, or a touch panel.

The terminal device 2 further includes a connector 201, a switch 202, a controller 203, a power management unit (PMU) 204 as a power management device, a charger integrated circuit (IC) 205, and a battery 206.

The connector 201 is a USB Type-C connector conforming to the USB Type-C standard.

The switch 202 changes over a connection destination of a signal input from or output from the connector 201 under the control of the controller 203. For example, the switch 202 connects or disconnects a connection between the connector 201 and the CPU 207.

The controller 203 is a USB Type-C controller conforming to the USB Type-C standard. The controller 203 performs a communication conforming to the USB Type-C standard with a device connected to the connector 201. According to the USB Type-C standard, a connection scheme is determined by that, the USB Type-C controllers of respective devices connected with the cables 3 exchange information about a direction of the power supply or a signal connection scheme. For example, the controller 203 receives a signal output from a USB device connected with the connector 201 and detects the specific USB device. The controller 203 controls the switch 202 to correspond with a detection result.

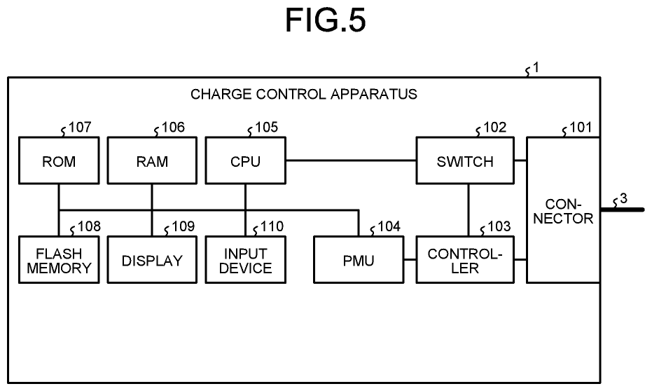

The controller 203 in the first embodiment exchanges information with the PMU 204. The controller 203 delivers a signal transmitted via the cable 3 and the power supply device 5 from a PMU 104 (illustrated in FIG. 5) to be described later of the charge control apparatus 1 to the PMU 204. Additionally, the controller 203 transmits a signal output from the PMU 204 to the PMU 104 of the charge control apparatus 1 via the cable 3 and the power supply device 5.

The charger IC 205 charges the battery 206 with power supplied via the cable 3. The charger IC 205 starts or stops charging the battery 206 based on the control of the PMU 204.

The PMU 204 manages power of the terminal device 2. The PMU 204 is a microcontroller including a processor and a memory. The PMU 204 controls the charger IC 205 to control charging of the battery 206. The PMU 204 transmits and receives information relating to control to and from the PMU 104 of the charge control apparatus 1. A method for communication between the PMU 204 and the PMU 104 of the charge control apparatus 1 may be an unstructured vendor defined message (UVDM). The method is not, however, limited thereto.

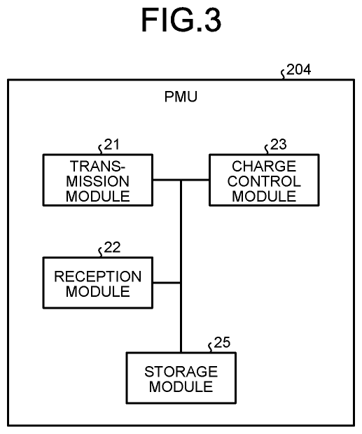

FIG. 3 is a diagram illustrating an example of a functional configuration of the PMU 204 of the terminal device 2 in the first embodiment. As illustrated in FIG. 3, the PMU 204 in the first embodiment includes a transmission module 21, a reception module 22, a charge control module 23, and a storage module 25.

The storage module 25 stores charge information relating to charge of the terminal device 2 and a processing program relating to charge control. The storage module 25 is, for example, a non-volatile memory.

The processing program executed by the PMU 204 has a modular configuration including the above-described functional modules (the transmission module 21, the reception module 22, and the charge control module 23). With regard to hardware operation, a processor reads out software programs from a memory and executes those programs. Thereby, the functional modules are loaded on a main memory, and the transmission module 21, the reception module 22, and the charge control module 23 are generated on the main memory.

The above-described functional modules (the transmission module 21, the reception module 22, and the charge control module 23) may be implemented by hardware circuitry.

The following describes charge information stored in the storage module 25.

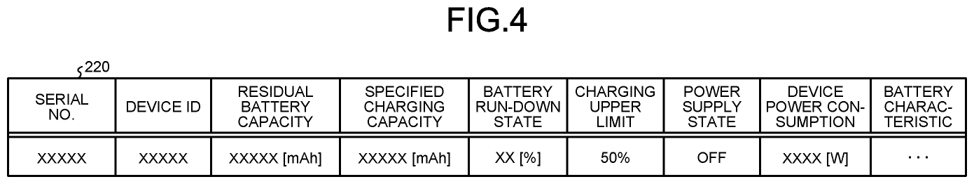

FIG. 4 is a diagram illustrating an example of charge information 220 in the first embodiment. As illustrated in FIG. 4, in the charge information 220, the following pieces of information are associated with each other: a serial number with which the battery 206 can be identified; a device ID with which the terminal device 2 can be identified; residual battery capacity (mAh) of the battery 206; specified charging capacity (mAh); a run-down state (%) of the battery 206; a charging upper limit (%); a power supply state; power consumption; and battery characteristics.

The specified charging capacity denotes power to be rechargeable at the time of production of the battery 206. Rechargeable power of the battery 206 decreases in accordance with deterioration due to the use. The run-down state indicates a rate of reduction in the charging capacity of the battery 206 to the specified charging capacity.

The charging upper limit denotes an upper limit value of a charging rate (%) of the battery 206.

The power supply state is information representing that the power supply of the terminal device 2 is in either an ON state or an OFF state. The OFF state may be referred to as a shutdown state.

The power consumption denotes power consumption of the terminal device 2. The battery characteristics denote characteristics of the battery 206 and are, for example, information relating to a pace at which the battery 206 charges and discharges.

Reference is made back to FIG. 3. The transmission module 21 transmits the charge information 220 to the charge control apparatus 1. When the reception module 22 receives a signal instructing a start of a communication from the charge control apparatus 1, the transmission module 21 transmits an acknowledge signal to the PMU 104 of the charge control apparatus 1.

The reception module 22 receives the charging upper limit transmitted from the charge control apparatus 1. The reception module 22 registers the received charge information 220. The reception module 22 also receives, from the charge control apparatus 1, a signal instructing a communication start or a request signal requesting transmission of the charge information 220. Upon receipt of the communication start signal or the request signal, the reception module 22 notifies the transmission module 21 of details of the received signal.

The charge control module 23 charges the battery 206 based on the control of the charge control apparatus 1.

More specifically, the charge control module 23 monitors the state of the battery 206 and the power supply state of the terminal device 2 and acquires the residual battery capacity, the run-down state, the power supply state, and the power consumption. The pieces of acquired information are set in the charge information 220. In addition, the charge control module 23 calculates the charging rate of the battery 206 at a current point in time by using the residual battery capacity, the run-down state, and the specified charging capacity.

When the charging rate at the current point in time is smaller than the charging upper limit registered with the charge information 220, the charge control module 23 controls the charger IC 205 to charge the battery 206 up to the charging upper limit. When the charging rate at the current point in time is equal to or greater than the charging upper limit registered with the charge information 220, the charge control module 23 does not charge the battery 206.

Even in a case where the power supply of the terminal device 2 is in the OFF state, the controller 203, the switch 202, and the PMU 204 are activated when power is supplied from the connector 201. The controller 203, the switch 202, and the PMU 204 operate even in a case where the CPU 207 is deactivated. Thus, the above-described functional modules (the transmission module 21, the reception module 22, and the charge control module 23) function even when the power supply of the terminal device 2 is in the OFF state.

The following describes a configuration of the charge control apparatus 1.

FIG. 5 is a diagram illustrating an example of a hardware configuration of the charge control apparatus 1 in the first embodiment. As illustrated in FIG. 5, the charge control apparatus 1 includes a CPU 105, a RAM 106, a ROM 107, an input device 110, a display 109, and a flash memory 108 or another external storage device. The input device 110 is, for example, a keyboard, a mouse, or a touch panel.

The charge control apparatus 1 further includes a connector 101, a switch 102, a controller 103, and the PMU 104.

The connector 101 is a USB Type-C connector conforming to the USB Type-C standard.

The switch 102 changes over a connection destination of a signal input or output from the connector 101 under the control of the controller 103. For example, the switch 102 connects or disconnects a connection between the connector 101 and the CPU 105.

The controller 103 is a USB Type-C controller conforming to the USB Type-C standard. The controller 103 exchanges information with the PMU 104. The controller 103 delivers a signal transmitted via the cable 3 and the power supply device 5 from the PMU 204 of the terminal device 2 to the PMU 104. Additionally, the controller 103 transmits a signal output from the PMU 104 to the PMU 204 of the terminal device 2 via the cable 3 and the power supply device 5.

The PMU 104 manages supply of power for the charge control apparatus 1. The PMU 104 is, for example, an IC chip including a processor (as the first hardware processor) and a memory. The PMU 104 transmits and receives information relating to control of the charging of the battery 206 to and from the PMU 204 of the terminal device 2.

More specifically, the PMU 104 communicates with the PMU 204 of each of the terminal devices 2a to 2c and registers an upper limit value with the PMU 204 of each of the terminal devices 2a to 2c.

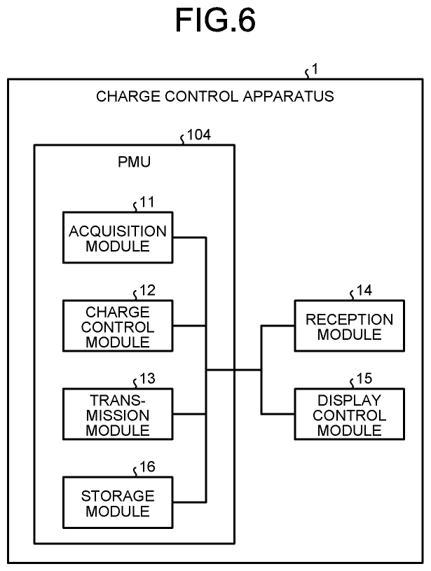

FIG. 6 is a diagram illustrating an example of a functional configuration of the charge control apparatus 1 in the first embodiment. As illustrated in FIG. 6, the charge control apparatus 1 in the first embodiment includes an acquisition module 11, a charge control module 12, a transmission module 13, a storage module 16, a reception module 14, and a display control module 15. The acquisition module 11, the charge control module 12, the transmission module 13, and the storage module 16 are included in the PMU 104. The charge control module 12 of the charge control apparatus 1 may be referred to as a first charge control module and the charge control module 23 of the terminal device 2 may be referred to as a second charge control module.

The reception module 14 receives, from the input device 110, the charging upper limit input by the administrator. The reception module 14 delivers the received charging upper limit to the charge control module 12.

The display control module 15 displays, on the display 109, the charge information 220 of each of the terminal devices 2a to 2c acquired by the acquisition module 11. The display control module 15 displays on the display 109 an input screen for the charging upper limit.

The storage module 16 stores the charge information 220 and a processing program relating to the charge control. The storage module 16 is a memory or the like. The storage module 16 may be provided outside the PMU 104. For example, the storage module 16 may be the ROM 107 or the flash memory 108.

The transmission module 13 transmits a communication start signal to the PMU 204 of the terminal device 2. When the acquisition module 11 receives an acknowledge signal from the terminal device 2, the transmission module 13 transmits to the terminal device 2 a request signal requesting transmission of the charge information 220.

The acquisition module 11 acquires the charge information 220 from each of the terminal devices 2a to 2c. The acquisition module 11 stores the received charge information 220 into the storage module 16. The acquisition module 11 receives an acknowledge signal from the PMU 204 of the terminal device 2. When the acknowledge signal is received, the acquisition module 11 notifies the transmission module 13 of the reception of the acknowledge signal.

The charge control module 12 controls the charging of the terminal device 2 on the basis of the charge information 220. More specifically, the charge control module 12 controls the charging upper limit of the battery provided in each of the terminal devices 2a to 2c by varying the charging upper limit registered with the charge information 220 of each of the terminal devices 2a to 2c.

In the first embodiment, when the charging upper limit is acquired from the reception module 14, the charge control module 12 transmits the acquired charging upper limit to each of the terminal devices 2a to 2c. As described above, the reception module 22 of the PMU 204 of the terminal device 2 registers the charging upper limit transmitted from the charge control apparatus 1 with the charge information 220. That is, the charge control module 12 controls the charging of the battery 206 of the terminal device 2 by transmitting the charging upper limit to the terminal device 2.

The processing program executed by the charge control apparatus 1 in the first embodiment has a modular configuration including the above-described functional modules (the reception module 14 and the display control module 15). With regard to hardware operation, the CPU 105 (as the second hardware processor) reads out software programs from a storage medium and executes those programs. Thereby, the functional modules are loaded on a main memory, and the reception module 14 and the display control module 15 are generated on the main memory.

The processing program executed by the PMU 104 has a modular configuration including the above-described functional modules (the acquisition module 11, the charge control module 12, and the transmission module 13). With regard to hardware operation, a processor reads out software programs from a memory. Thereby, the functional modules are loaded on a main memory, and the acquisition module 11, the charge control module 12, and the transmission module 13 are generated on the main memory.

The above-described functional modules (the reception module 14, the display control module 15, the acquisition module 11, the charge control module 12, and the transmission module 13) may be implemented by hardware circuitry.

The following describes a configuration of the power supply device 5.

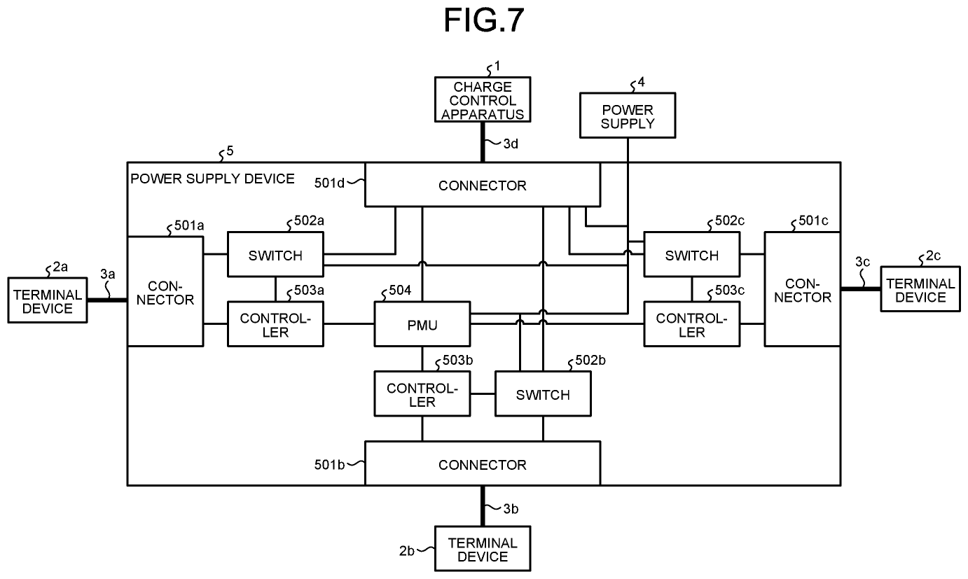

FIG. 7 is a diagram illustrating an example of a hardware configuration of the power supply device 5 in the first embodiment. As illustrated in FIG. 7, the power supply device 5 includes connectors 501a to 501d, switches 502a to 502c, controllers 503a to 503c, and a PMU 504.

The connectors 501a to 501d (hereinafter referred to as a connector 501 or connectors 501 when one is not to be differentiated from others) are each a USB Type-C connector conforming to the USB Type-C standard.

In the example illustrated in FIG. 7, the connector 501a is connected with the terminal device 2a via the cable 3a. The connector 501a is connected with the switch 502a and the controller 503a. The connector 501b is connected with the terminal device 2b via the cable 3b. The connector 501b is connected with the switch 502b and the controller 503b. The connector 501c is connected with the terminal device 2c via the cable 3c. The connector 501c is connected with the switch 502c and the controller 503c. The connectors 501a to 501c supply power that is supplied via the switches 502a to 502c, respectively, from the power supply 4 to the terminal devices 2a to 2c via the cables 3a to 3c, respectively.

The connector 501d is connected to the charge control apparatus 1 via the cable 3d. The connector 501d is connected with the switches 502a to 502c and the PMU 504. The connector 501d outputs, to the switches 502a to 502c, information transmitted via the cable 3d from the charge control apparatus 1. The information transmitted from the charge control apparatus 1 is, for example, the charging upper limit. Additionally, the connector 501d acquires, from the switches 502a to 502c, information transmitted from the terminal devices 2a to 2c via the cables 3a to 3c and the connectors 501a to 501c. The information transmitted from the terminal devices 2a to 2c is, for example, the charge information 220.

The connector 501d supplies power that is supplied from the power supply 4 to the charge control apparatus 1 via the cable 3d. When the charge control apparatus 1 obtains power from another power supply, not via the power supply device 5, the connector 501d is not required to supply the power supplied from the power supply 4 to the charge control apparatus 1.

The PMU 504 communicates with each of the controllers 503. The PMU 504 may transmit and receive information to and from the charge control apparatus 1 via the connector 501d.

The power supply 4 supplies power to the PMU 504, the connector 501d, and the switches 502a to 502c.

The switches 502a to 502c (hereinafter referred to as the switch 502 or switches 502 when one is not to be differentiated from others) each change over a connection destination of a signal input or output from a corresponding one of the connectors 501a to 501c under the control of a controller 503a to 503c, respectively. For example, the switches 502a to 502c output information transmitted from the terminal devices 2a to 2c via the cables 3a to 3c and the connectors 501a to 501c, respectively, to the connector 501d. The switches 502a to 502c also output information transmitted from the charge control apparatus 1 via the cable 3d and the connector 501d to the connectors 501a to 501c, respectively. The information transmission path within the power supply device 5 is not limited thereto.

The switch 502 outputs, to the connectors 501a to 501c, power that is supplied from the power supply 4.

Each of the controllers 503a to 503c (hereinafter referred to as a controller 503 or controllers 503) is a USB Type-C controller conforming to the USB Type-C standard.

The number of connectors 501, the number of switches 502, and the number of controllers 503 illustrated in FIG. 7 are not limited thereto and the numbers may be equal to or greater than the number of charge control apparatuses 1 and the number of terminal devices 2.

The following describes a charge control process performed by the charge control system S1, which is configured as described above.

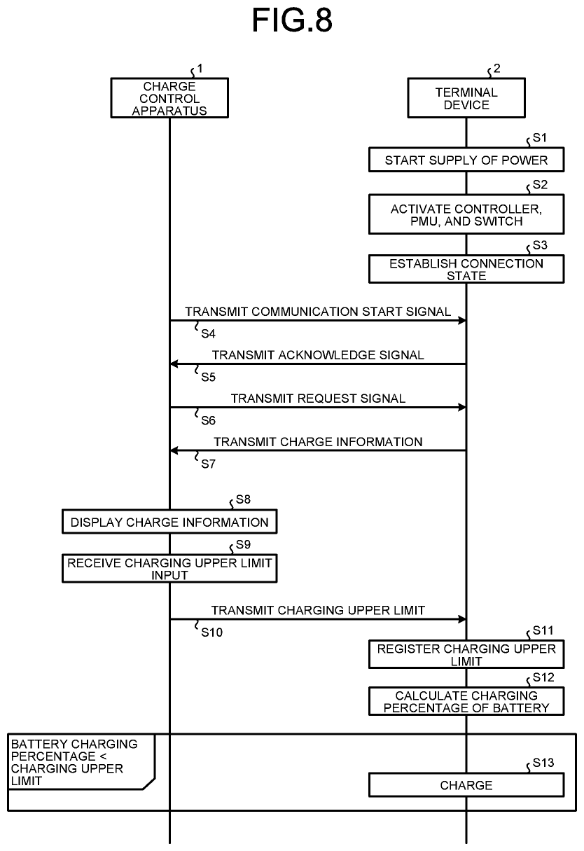

FIG. 8 is a sequence diagram illustrating an example of the charge control process in the first embodiment. It is assumed that, before the processing illustrated in FIG. 8 is started, the power supply of the terminal device 2 is in the OFF state, and the charge control apparatus 1 is connected with the power supply device 5 via the cable 3.

While the power supply device 5 relays transmission and reception of information between the charge control apparatus 1 and the terminal device 2, it does not perform processing such as making a decision or editing information. Thus, in the processing illustrated in FIG. 8, a process of the power supply device 5 is omitted. Although a plurality of terminal devices 2 exist, FIG. 8 illustrates a single terminal device 2 because the terminal devices 2 each perform an identical process.

The cable 3 is connected to the connector 201 of the terminal device 2 by a user or the like. It is assumed here that this cable 3 is connected with the power supply device 5. In this case, supply of power from the power supply device 5 to the controller 203, the switch 202, and the PMU 204 is started (S1) and the controller 203, the switch 202, and the PMU 204 are activated (S2).

When the battery 206 of the terminal device 2 has residual capacity, the controller 203, the switch 202, and the PMU 204 may have been continuously activated by discharge power of the battery 206 before the supply of power from the power supply device 5 was started.

The controller 203 of the terminal device 2 establishes a connection state conforming to the USB Type-C standard by communicating with the controller 103 of the charge control apparatus 1 via the power supply device 5 (S3).

When the connection state is established between the controller 103 of the charge control apparatus 1 and the controller 203 of the terminal device 2, the transmission module 13 of the PMU 104 of the charge control apparatus 1 transmits a communication start signal to the PMU 204 of the terminal device 2 via the controller 103 (S4).

When the PMU 204 of the terminal device 2 receives the communication start signal, the transmission module 21 of the PMU 204 transmits an acknowledge signal to the PMU 104 of the charge control apparatus 1 (S5).

When the PMU 104 of the charge control apparatus 1 receives the acknowledge signal, the transmission module 13 of the PMU 104 transmits a request signal to the PMU 204 of the terminal device 2 (S6).

When the PMU 204 of the terminal device 2 receives the request signal, the transmission module 21 of the PMU 204 transmits the charge information 220 to the PMU 104 of the charge control apparatus 1 (S7).

The acquisition module 11 of the PMU 104 of the charge control apparatus 1 acquires the charge information 220, which has been transmitted from the PMU 204, and stores the charge information 220 into the storage module 16.

The display control module 15 of the charge control apparatus 1 displays the charge information 220 on the display 109 (S8). Although FIG. 8 representatively illustrates a single terminal device 2, it is assumed that the charge control apparatus 1 acquires the charge information 220 from each of the terminal devices 2a to 2c included in the charge control system S1 and displays pieces of the acquired charge information 220 on the display 109.

The administrator or the like can thereby recognize the charge information 220 of each of the terminal devices 2a to 2c. When, for example, the power supply of the terminal device 2, which is put into the charge management rack 6, is in the ON state, heat tends to accumulate inside the charge management rack 6 or the terminal device 2 can consume additional power. Thus, the power supply of the terminal device 2 is desirably in the OFF state. In such a case, the administrator can readily recognize, with the charge information 220 displayed on the display 109, whether the power supply of each of the terminal devices 2a to 2c is in the OFF state.

The administrator inputs the charging upper limit of the terminal device 2 to the charge control apparatus 1. In this case, the reception module 14 of the charge control apparatus 1 receives, from the input device 210, the charging upper limit input by the administrator (S9). The reception module 14 delivers the input charging upper limit to the charge control module 12.

The charge control module 12 of the PMU 104 of the charge control apparatus 1 transmits the input charging upper limit to the PMU 204 of the terminal device 2 (S10).

The reception module 22 of the PMU 204 of the terminal device 2 registers the charging upper limit, which has been transmitted from the charge control apparatus 1, with the charge information 220 in the storage module 25 (S11).

The charge control module 23 of the PMU 204 of the terminal device 2 calculates the charging rate (or percentage) of the battery 206 at the current point in time by using the residual battery capacity, the run-down state, and the specified charging capacity contained in the charge information 220 (S12).

When the charging rate of the battery 206 at the current point in time is smaller than the charging upper limit registered with the charge information 220, the charge control module 23 controls the charger IC 205 to charge the battery 206 up to the charging upper limit (S13).

When the charging rate of the battery 206 at the current point in time is equal to or greater than the charging upper limit registered with the charge information 220, the charge control module 23 does not charge the battery 206. At this point, the charge control process is terminated.

As described above, the charge control apparatus 1 in the first embodiment acquires the charge information 220 from each of the terminal devices 2a to 2c and controls charging of the terminal devices 2a to 2c on the basis of the charge information 220. The charge control apparatus 1 in the first embodiment can thereby externally control the charging of one or more terminal devices 2a, 2b, and 2c.

The charge information 220 in the first embodiment includes the upper limit value of the charging rate of the battery 206 provided in each of the terminal devices 2a to 2c. The charge control apparatus 1 in the first embodiment controls the charging upper limit of the battery 206 of each of the terminal devices 2a to 2c by varying the upper limit value of the charge information 220 registered with each of the terminal devices 2a to 2c.

By controlling the charging upper limit of the battery 206, it is possible to retard deterioration of the battery 206.

This is because, for example, the deterioration of the battery 206 is, in general, retarded by charging the battery 206 with a charge amount that has been set to an upper limit lower than a full charge, compared with a case in which the full charge is set as the upper limit. In the known art, when a function to control the charging upper limit is not provided in a PMU of a terminal device, the PMU keeps the battery being fully charged at all times as long as the power is supplied. Thus, when the power supply is connected over an extended period of time at, for example, the nighttime, the deterioration of the battery may be accelerated.

Additionally, in the known art, even when the PMU of the terminal device is provided with the function to control the charging upper limit, the entire terminal device needs to be restarted in order for the user to change the charging upper limit set in the PMU. In this case, if there are terminal devices needing to be charged, the user or the administrator is required to turn on the power of all those terminal devices and carries out operation of changing the settings of the PMUs, so that a work load on the user or the administrator may increase.

In contrast, according to the first embodiment of the present disclosure, the charge control apparatus 1 controls the charging upper limit of the battery 206 of each of the terminal devices 2a to 2c by varying the upper limit value of the charge information 220 registered with each of the terminal devices 2a to 2c. Thus, the battery 206 can be avoided from becoming fully charged even when the terminal devices 2a to 2c are kept connected with the power supply over an extended period of time. Thus, the deterioration of the battery 206 can be retarded. In addition, it is possible to perform batch processing of the charging upper limits of the terminal devices 2a to 2c, so that the work load on the user or the administrator can be reduced.

The charge control apparatus 1 in the first embodiment includes the PMU 104. The PMU 104 is provided with the charge control module 12. The PMU 104 communicates with the PMU 204 of each of the terminal devices 2a to 2c and registers the charging upper limit with the PMU 204 of each of the terminal devices 2a to 2c. The PMU 204 is activated even when the power supplies of the terminal devices 2a to 2c are in the OFF state. Therefore, the charge control apparatus 1 in the first embodiment can control charging of the terminal devices 2a to 2c even when the power supplies of the terminal devices 2a to 2c are in the OFF state.

The charge control system S1 in the first embodiment includes the charge control apparatus 1 and one or more terminal devices 2a, 2b, and 2c. The charge control apparatus 1 acquires the charge information 220 from each of the terminal devices 2a to 2c and controls charging of the terminal devices 2a to 2c on the basis of the charge information 220. The terminal devices 2a to 2c each transmit the charge information 220 to the charge control apparatus 1 and charge the battery 206 under the control of the charge control apparatus 1. Thus, according to the charge control system S1 in the first embodiment, the charging of the terminal devices 2a to 2c can be controlled by the charge control apparatus 1.

In the first embodiment, it is assumed that the cable 3, and the connector 201, the controller 203, and the switch 202 of the terminal device 2 conform to the USB Type-C standard. The USB Type-C standard is, however, not the only possible standard to be complied with. Any other standard may be adopted when, for example, the standard enables the control signal and the power supply to be supplied and enables the connector 201, the controller 203, the switch 202, and the PMU 204 to be operative even when the CPU 207 of the terminal device 2 is not activated.

It is noted that the cable 3d, which connects the charge control apparatus 1 with the power supply device 5, may be any type of cable other than the USB Type-C cable, for example, a LAN cable. The charge control apparatus 1 may wirelessly communicate with the power supply device 5.

While the PMU 104 of the charge control apparatus 1 has been described in the first embodiment as having a function as the charge control module 12, the PMU 104 may serve as an example of the first hardware processor in the scope of claims of the present disclosure. Additionally, the controller 103 may serve as an example of the first hardware processor in the scope of the claims. The input device 110 may serve as an example of the second hardware processor in the scope of the claims.

While the PMU 204 of the terminal device 2 has been described in the first embodiment as having a function as the second charge control module, the PMU 204 may serve as an example of the hardware processor in the scope of the claims. Additionally, the controller 203 may serve as an example of the hardware processor in the scope of the claims.

### Second Embodiment

In the first embodiment described above, the charge control apparatus 1 controls the charging upper limit of the terminal device 2. In the second embodiment to be described below, a charge control apparatus 1 varies the charging upper limit of a terminal device 2 depending on time slots.

A charge control system S1 of the second embodiment has a whole configuration identical to the whole configuration of the charge control system S1 of the first embodiment. The charge control apparatus 1, the terminal device 2, and a power supply device 5 each have a configuration identical to the configuration in the first embodiment.

The charge control apparatus 1 includes, as in the first embodiment, a CPU 105, a RAM 106, a ROM 107, an input device 110, a display 109, a flash memory 108 or another external storage device, a connector 101, a switch 102, a controller 103, and a PMU 104.

The charge control apparatus 1 in the second embodiment includes, as in the first embodiment, an acquisition module 11, a charge control module 12, a storage module 16, a reception module 14, and a display control module 15. The acquisition module 11, the charge control module 12, the transmission module 13, and the storage module 16 are included in the PMU 104. The acquisition module 11 has functions similar to the functions in the first embodiment.

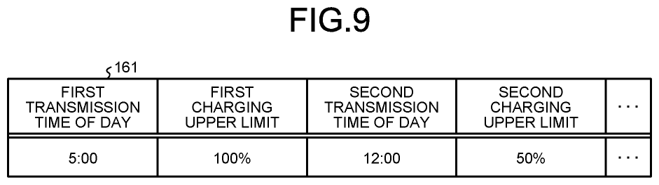

In addition to the information similar to the information stored in the first embodiment, the storage module 16 in the second embodiment stores transmission time information in which a plurality of times of day are associated with a plurality of charging upper limits. FIG. 9 is a diagram illustrating an example of transmission time information 161 in the second embodiment. As illustrated in FIG. 9, the transmission time information 161 includes a first transmission time of day “05:00”, a first charging upper limit “100%”, a second transmission time of day “12:00”, and a second charging upper limit “50%”. The first transmission time of day differs from the second transmission time of day. The first charging upper limit differs from the second charging upper limit. The values of the transmission time information 161 are not limited thereto. The first charging upper limit is an example of the first upper limit and the second charging upper limit is an example of the second upper limit.

In addition to functions similar to the functions in the first embodiment, the charge control module 12 in the second embodiment has a function to transmit the first charging upper limit to the terminal device 2 at the first transmission time of day stored in the storage module 16 and transmit the second charging upper limit to the terminal device 2 at the second transmission time of day.

In addition to functions similar to the functions in the first embodiment, the display control module 15 in the second embodiment has a function to display on the display 109 an input screen that allows inputting a plurality of transmission times of day and a plurality of charging upper limits.

In addition to functions similar to the functions in the first embodiment, the reception module 14 in the second embodiment has a function to receive inputs of a plurality of transmission times of day and a plurality of charging upper limits. For example, the reception module 14 in the second embodiment receives inputs of the first transmission time of day, the first charging upper limit, the second transmission time of day, and the second charging upper limit. The reception module 14 registers the received transmission times of day and charging upper limits with the transmission time information 161 in the storage module 16.

In the second embodiment, the first transmission time of day and the second transmission time of day are set by the administrator.

The following describes a charge control process performed by the charge control system S1 configured as described above.

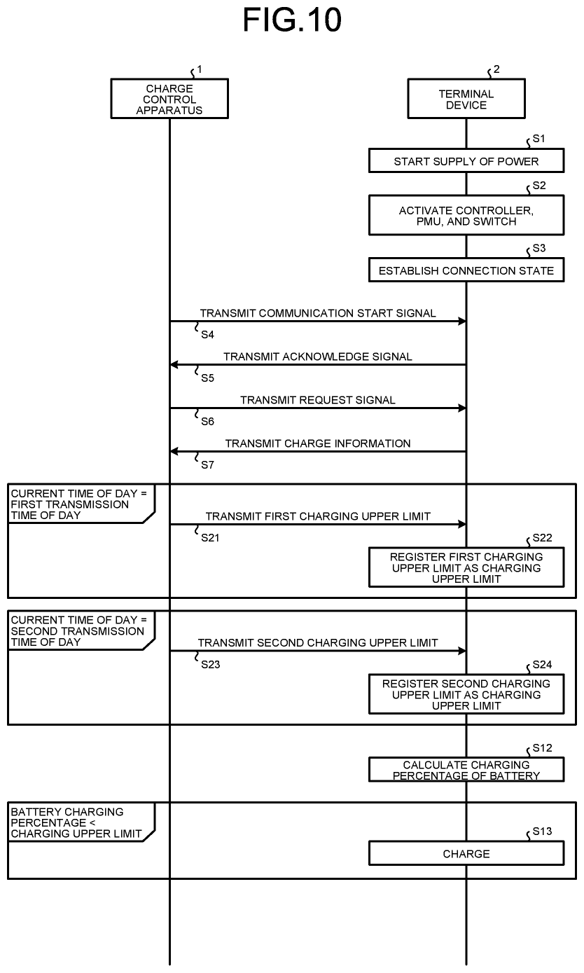

FIG. 10 is a sequence diagram illustrating an example of the charge control process in the second embodiment. In the second embodiment, the first transmission time of day, the first charging upper limit, the second transmission time of day, and the second charging upper limit are input in advance by the administrator and stored in the storage module 16.

In FIG. 10, the steps from power supply start at S1 to transmission of charge information at S7 are identical to those in the first embodiment (FIG. 8).

The charge control module 12 determines whether a current time of day is the first transmission time of day. When it is determined that the current time of day is the first transmission time of day, the charge control module 12 transmits the first charging upper limit to a PMU 204 of the terminal device 2 (S21).

In this case, a reception module 22 of the PMU 204 of the terminal device 2 registers, as the charging upper limit, the first charging upper limit transmitted from the charge control apparatus 1 with charge information 220 of a storage module 25 (S22).

When it is determined that the current time of day is not the first transmission time of day, the charge control module 12 determines whether the current time of day is the second transmission time of day. When it is determined that the current time of day is the second transmission time of day, the charge control module 12 transmits the second charging upper limit to the PMU 204 of the terminal device 2 (S23).

In this case, the reception module 22 of the PMU 204 of the terminal device 2 registers, as the charging upper limit, the second charging upper limit transmitted from the charge control apparatus 1 with the charge information 220 of the storage module 25 (S24).

The step of calculation of the charging percentage of a battery 206 at S12 is identical to that in the first embodiment.

When the charging rate at the current point in time of the battery 206 is smaller than the charging upper limit registered with the charge information 220, a charge control module 23 of the PMU 204 of the terminal device 2 controls a charger IC 205 to charge the battery 206 up to the charging upper limit (S13). In the second embodiment, the charging upper limit registered with the charge information 220 is the first charging upper limit at the first transmission time of day. Thus, the charge control module 23 charges the battery 206 up to the first charging upper limit. Additionally, the charging upper limit registered with the charge information 220 is the second charging upper limit at the second transmission time of day. Thus, the charge control module 23 charges the battery 206 up to the second charging upper limit.

As described above, in accordance with the charge control apparatus 1 in the second embodiment, the first charging upper limit is transmitted to the terminal device 2 at the first transmission time of day, and the second charging upper limit is transmitted to the terminal device 2 at the second transmission time of day. Thus, in addition to the effects achieved by the first embodiment, the charging upper limit of the battery 206 can be easily varied according to the time of day.

For example, if assuming that the user uses the terminal device 2 from 9:00 a.m., a need exists for the battery 206 of the terminal device 2 being fully charged at 9:00 a.m. In such case, instead of keeping the battery 206 fully charged over the nighttime, the battery 206 may be fully charged immediately before 9:00 a.m. This approach allows the deterioration of the battery 206 to be retarded. In accordance with the charge control apparatus 1 in the second embodiment, when the administrator sets the first transmission time of day to, for example, 5:00 a.m. and the first charging upper limit to 100% in advance, charging can be started at 5:00 a.m. toward a target of 100% charging. Thus, the battery 206 can be fully charged at an appropriate time.

Meanwhile, recently, there is a need for a peak cut of power consumption by the charging at the nighttime instead of the daytime during which power consumption generally increases. The need for the peak cut also arises due to an economical aspect because electricity charges can be lower at the nighttime than the daytime. In accordance with the charge control apparatus 1 in the second embodiment, for example, by setting the upper limit value for the daytime to a value smaller than the upper limit value for the nighttime, it is possible to charge the battery 206 at the nighttime more than at the daytime. Accordingly, the peak cut can be achieved.

Additionally, the charge control apparatus 1 in the second embodiment receives the inputs of the first transmission time of day, the first charging upper limit, the second transmission time of day, and the second charging upper limit. Thus, the battery 206 can be charged up to an upper limit value required by the administrator at any time of day required by the administrator.

It is noted that, instead the transmission times of day, a plurality of transmission time slots and upper limit values associated with the respective transmission time slots may be registered with the transmission time information 161. In this case, the charge control module 12 determines a specific transmission time slot that includes the current time of day and transmits the upper limit value associated with the specific transmission time slot to the terminal device 2.

### Third Embodiment

In the second embodiment described above, the transmission time of day of the charging upper limit is set by the administrator. In a third embodiment to be described below, a charge control apparatus 1 calculates the transmission time of day of the charging upper limit based on a charging completion time of day.

A whole configuration of a charge control system S1 in the third embodiment is identical to the whole configuration of the charge control system S1 in the first embodiment. The charge control apparatus 1, a terminal device 2, and a power supply device 5 each have a configuration identical to the configuration in the first embodiment.

The charge control apparatus 1 includes, as in the first embodiment, a CPU 105, a RAM 106, a ROM 107, an input device 110, a display 109, a flash memory 108 or another external storage device, a connector 101, a switch 102, a controller 103, and a PMU 104.

The charge control apparatus 1 in the third embodiment includes, as in the first embodiment, an acquisition module 11, a charge control module 12, a storage module 16, a reception module 14, and a display control module 15. The acquisition module 11, the charge control module 12, the transmission module 13, and the storage module 16 are included in the PMU 104. The acquisition module 11 has functions similar to the functions in the first embodiment.

The storage module 16 stores a plurality of charging completion time of days, in addition to information similar to the information in the second embodiment. More specifically, transmission time information 161 in the third embodiment further includes a first charging completion time of day and a second charging completion time of day.

In addition to functions similar to the functions in the first embodiment, the reception module 14 in the third embodiment has a function to receive a plurality of charging completion times of day and a plurality of charging upper limits. For example, the reception module 14 receives inputs of the first charging completion time of day, the first charging upper limit, the second charging completion time of day, and the second charging upper limit. The first charging completion time of day represents a time of day different from the second charging completion time of day. The reception module 14 registers the charging completion times of day and the charging upper limits with the transmission time information 161 in the storage module 16.

The charging completion time of day represents a target time of day at which a battery 206 is charged up to the charging upper limit.

In addition to functions similar to the functions in the first embodiment, the display control module 15 in the third embodiment has a function to display, on the display 109, an input screen that allows inputting a plurality of charging completion times of day and a plurality of charging upper limits.

In addition to functions similar to the functions in the first embodiment, the charge control module 12 in the third embodiment has a function to calculate a first charging time length required for charging the battery 206 of each of the terminal devices 2a to 2c up to a corresponding one of the charging upper limits registered with the transmission time information 161.

Specifically, the charge control module 12 calculates, based on the battery characteristics and the residual battery capacity of each of the terminal devices 2a to 2c registered with the charge information 220, the first charging time length required for charging the battery 206 of each of the terminal devices 2a to 2c up to the corresponding one of the first charging upper limits. Additionally, the charge control module 12 calculates, based on the battery characteristics and the residual battery capacity, a second charging time length required for charging the battery 206 of each of the terminal devices 2a to 2c up to the corresponding one of the second charging upper limits.

The charge control module 12 calculates a first transmission time of day by subtracting the first charging time length from the first charging completion time of day. The charge control module 12 calculates a second transmission time of day by subtracting the first charging time length from the second charging completion time of day. The charge control module 12 registers the calculated first transmission time of day and second transmission time of day with the transmission time information 161 in the storage module 16.

As described above, the charge control apparatus 1 in the third embodiment calculates the first transmission time of day or the second transmission time of day based on the first charging completion time of day or the second charging completion time of day. Thus, the administrator is not required to perform manual calculation from the target charging completion time of day. Therefore, in addition to the effects achieved by the foregoing first and second embodiments, the charge control apparatus 1 in the third embodiment can reduce a work load on the administrator.

The method for calculating the first transmission time of day or the second transmission time of day is not limited to the one described above. For example, the charge control module 12 may estimate the time length required for the charging on the basis of past records of the charging time.

### Fourth Embodiment

In the second and third embodiments described above, the charging upper limit is varied according to a plurality of transmission times of day on the side of the charge control apparatus 1. In a fourth embodiment to be described below, a terminal device 2 stores the charging upper limits to be individually applied to each individual time slot.

A whole configuration of a charge control system S1 in the fourth embodiment is identical to the whole configuration of the charge control system S1 in the first embodiment. A charge control apparatus 1, the terminal device 2, and a power supply device 5 each have a configuration identical to the configuration in the first embodiment.

The terminal device 2 in the fourth embodiment includes, as in the first embodiment, a CPU 207, a RAM 208, a ROM 209, an input device 210, a display 211, a flash memory 212 or another external storage device, a connector 201, a switch 202, a controller 203, a PMU 204, a charger IC 205, and a battery 206. The PMU 204 includes, as in the first embodiment, a transmission module 21, a reception module 22, a charge control module 23, and a storage module 25. The transmission module 21 has functions similar to the functions in the first embodiment.

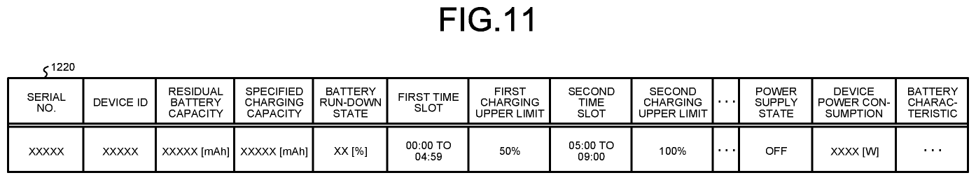

The following describes charge information stored in the storage module 25 in the fourth embodiment with reference to FIG. 11. FIG. 11 is a diagram illustrating an example of charge information 1220 in the fourth embodiment. As illustrated in FIG. 11, the charge information 1220 associates the following pieces of information with each other: a serial number with which the battery 206 can be identified; a device ID with which the terminal device 2 can be identified; residual battery capacity (mAh) of the battery 206; specified charging capacity (mAh); a run-down state (%) of the battery 206; a power supply state; power consumption; battery characteristics; a plurality of time slots; and a plurality of charging upper limits.

In the example illustrated in FIG. 11, the charge information 1220 includes a first time slot, a first charging upper limit, a second time slot, and a second charging upper limit.

In addition to functions similar to the functions in the first embodiment, the reception module 22 in the fourth embodiment has a function to receive, from the charge control apparatus 1, the first time slot, the first charging upper limit, the second time slot, and the second charging upper limit.

In addition to functions similar to the functions in the first embodiment, the charge control module 23 has a function to charge the battery 206 up to the charging upper limit that varies according to the time slot. Specifically, when the charging rate of the battery 206 is smaller than the first charging upper limit registered with the charge information 1220, the charge control module 23 charges the battery 206 up to the first charging upper limit in the first time slot. When the charging rate of the battery 206 is smaller than the second charging upper limit registered with the charge information 1220, the charge control module 23 charges the battery 206 up to the second charging upper limit in the second time slot.

When the charging rate of the battery 206 is equal to or greater than the first charging upper limit registered with the charge information 1220, the charge control module 23 does not charge the battery 206 in the first time slot. When the charging rate of the battery 206 is equal to or greater than the second charging upper limit registered with the charge information 1220, the charge control module 23 does not charge the battery 206 in the second time slot.

The charge control apparatus 1 in the fourth embodiment includes, as in the first embodiment, a CPU 105, a RAM 106, a ROM 107, an input device 110, a display 109, a flash memory 108 or another external storage device, a connector 101, a switch 102, a controller 103, and a PMU 104.

The charge control apparatus 1 in the fourth embodiment includes, as in the first embodiment, an acquisition module 11, a charge control module 12, a storage module 16, a reception module 14, and a display control module 15.

In addition to functions similar to the functions in the first embodiment, the charge control module 12 of the charge control apparatus 1 in the fourth embodiment has a function to transmit, to the terminal device 2, the charging upper limits to be individually applied to each individual time slots. Specifically, the charge control module 12 transmits, to the PMU 204 of the terminal device 2, the first time slot, the first charging upper limit, the second time slot, and the second charging upper limit.

As described above, according to the charge control apparatus 1 in the fourth embodiment, the charging upper limits to be individually applied to each individual time slot are transmitted to the terminal device 2. Therefore, in addition to the effects being achieved by the first embodiment, the terminal device 2 can thereby control the charging upper limits of the time slots.

### Fifth Embodiment

In the foregoing first to fourth embodiments, the charge control apparatus 1 and the terminal device 2 are connected via the power supply device 5. This method of connecting the charge control apparatus 1 with the terminal device 2 is not limited thereto. In a fifth embodiment to be described below, a charge control apparatus 1 is connected with a terminal device 2 in a one-to-one relation via a cable 3.

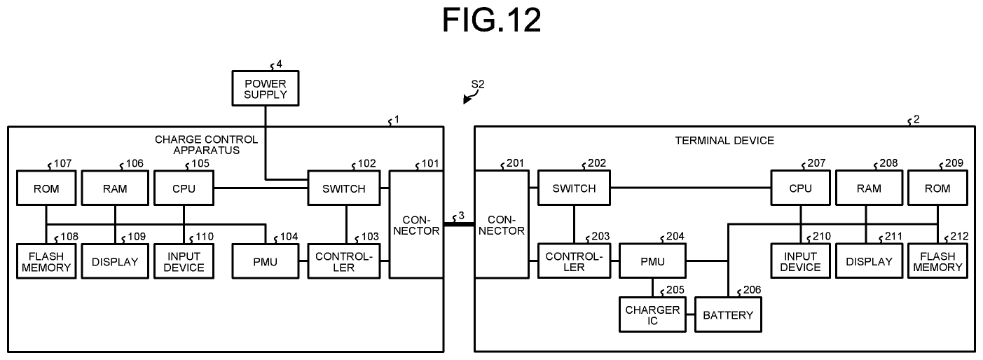

FIG. 12 is a diagram illustrating an example of a whole configuration of a charge control system S2 in the fifth embodiment. As illustrated in FIG. 12, the charge control apparatus 1 in the fifth embodiment includes, as in the first embodiment, a CPU 105, a RAM 106, a ROM 107, an input device 110, a display 109, a flash memory 108 or another external storage device, a connector 101, a switch 102, a controller 103, and a PMU 104.

In the fifth embodiment, the charge control apparatus 1 obtains power from a power supply 4. The power obtained by the charge control apparatus 1 from the power supply 4 is supplied to the terminal device 2 via the switch 102 and the connector 101.

The elements of the charge control apparatus 1 have functions identical to the functions in the first embodiment.

As illustrated in FIG. 12, the terminal device 2 in the fifth embodiment includes, as in the first embodiment, a CPU 207, a RAM 208, a ROM 209, an input device 210, a display 211, a flash memory 212 or another external storage device, a connector 201, a switch 202, a controller 203, a PMU 204, a charger IC 205, and a battery 206.

The elements of the terminal device 2 have functions identical to the functions in the first embodiment.

In addition to the effects achieved by the first embodiment, the charge control system S2 in the fifth embodiment can control charging of the battery 206 of the terminal device 2 by the charge control apparatus 1 without using the power supply device 5.

As described above, according to the first to fifth embodiments, the charging of one or more terminal devices 2a, 2b, and 2c can be externally controlled.

The processing program executed by the charge control apparatus 1 or the terminal device 2 in each of the first to fifth embodiments described above is recorded and provided in a computer-readable recording medium such as a compact disc read only memory (CD-ROM), a flexible disk (FD), a compact disc recordable (CD-R), and a digital versatile disc (DVD), as an installable or executable file.

Processing programs executed by the charge control apparatus 1 or the terminal device 2 in each embodiment described above may be stored in a computer connected to a network such as the Internet and provided by being downloaded via the network. Furthermore, processing programs executed by the charge control apparatus 1 or the terminal device 2 in each embodiment described above may be provided or distributed via a network such as the Internet. The program executed by the charge control apparatus 1 or the terminal device 2 in each embodiment described above may even be incorporated in advance and provided in, for example, a ROM.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A charge control apparatus comprising:
a memory; and
a first hardware processor coupled to the memory, wherein the first hardware processor:
acquires, from one or more terminal devices, charge information relating to a charge of the one or more terminal devices; and
controls charging of the one or more terminal devices based on the charge information.

2. The charge control apparatus according to claim 1, wherein
the charge information includes an upper limit value of a charging rate of a battery provided in each of the one or more terminal devices, and
the first hardware processor further controls a charging upper limit of the battery provided in each of the one or more terminal devices by varying the upper limit value of the charge information registered with the corresponding terminal device.

3. The charge control apparatus according to claim 1, further comprising a power management device in which the first hardware processor is provided,
wherein the power management device:
communicates with a power management device provided in each of the one or more terminal devices; and
registers, with the power management device provided in each of the one or more terminal devices, an upper limit value of a charging rate of a battery provided in each of the one or more terminal devices.

4. The charge control apparatus according to claim 1, wherein the first hardware processor further:
transmits a first upper limit value to the one or more terminal devices at a first transmission time of day; and
transmits a second upper limit value, which is different from the first upper limit value, to the one or more terminal devices at a second transmission time of day that is different from the first transmission time of day.

5. The charge control apparatus according to claim 4, further comprising a second hardware processor that receives inputs of the first transmission time of day, the first upper limit value, the second transmission time of day, and the second upper limit value.

6. The charge control apparatus according to claim 4, further comprising a second hardware processor that receives inputs of a first charging completion time of day, the first upper limit value, a second charging completion time of day that is different from the first charging completion time of day, and the second upper limit value, wherein
the charge information includes battery characteristics and residual battery capacity of each of the one or more terminal devices, and
the first hardware processor further:
calculates, based on the battery characteristics and the residual battery capacity of each of the one or more terminal devices, a first charging time length required for charging the battery of each of the one or more terminal devices up to the first upper limit value and a second charging time length required for charging the battery of each of the one or more terminal devices up to the second upper limit value;
calculates the first transmission time of day by subtracting the first charging time length from the first charging completion time of day; and
calculates the second transmission time of day by subtracting the second charging time length from the second charging completion time of day.

7. The charge control apparatus according to claim 2, wherein the first hardware processor further transmits, to the one or more terminal devices, the upper limit values to be individually applied to each individual time slot.

8. A charge control system comprising:
a charge control apparatus; and
one or more terminal devices, wherein
the charge control apparatus includes a memory and a hardware processor coupled to the memory, wherein the hardware processor:
acquires, from one or more terminal devices, charge information relating to a charge of the one or more terminal devices; and
controls charging of the one or more terminal devices based on the charge information, and
each of the one or more terminal devices includes a memory and a hardware processor coupled to the memory, the hardware processor of each of the one or more terminal devices:
transmits the charge information to the charge control apparatus; and
charges a battery based on control by the charge control apparatus.
